(19) United States
(12) Patent Application Publication
(10) Pub. No.: US 2013/0183967 A1
(43) Pub. Date: Jul. 18, 2013

(54) Lawful Intercept Of Mobile Units In Proximity To A Target Mobile Unit

(71) Applicants: Tim J. Olker, Warrenville, IL (US); Leslie J. Williams, Naperville, IL (US)

(72) Inventors: Tim J. Olker, Warrenville, IL (US); Leslie J. Williams, Naperville, IL (US)

(21) Appl. No.: 13/350,469

(22) Filed: Jan. 13, 2012

(51) Int. Cl. H04W 4/02; H04W 60/00

(52) U.S. Cl. 455/435.1; 455/456.6

(57) ABSTRACT

A method for performing lawful intercept of mobile units in proximity to a target mobile unit is provided. A first mobile unit to target is identified. A geographical area about the first mobile unit is defined. Wireless networks record any other mobile units that enter the geographical area and report these mobile units to a law enforcement agency.

### FIELD OF THE INVENTION

The present invention relates generally to communication systems, and more particularly to surveillance of mobile units.

### BACKGROUND OF THE INVENTION

Tracking suspected criminals is vital in the maintaining of order in society. As mobile units, such as cell phones, become ubiquitous, they are often used by those in the process of committing or planning criminal acts.

Focusing on a fixed geographic location can be useful when authorities know that suspected criminals will be in that location. However, suspected criminals rarely plan to have repeated meetings at fixed locations. In addition, with suspected criminals routinely moving, this method becomes less and less useful.

Therefore, a need exists for a way of tracking suspected criminals who are on the move and meeting in various geographical locations.

### BRIEF SUMMARY OF THE INVENTION

An exemplary embodiment of the present invention relates to a method for performing lawful intercept of mobile units in proximity to a target mobile unit.

A Law Enforcement Agency (LEA) submits a court order to a wireless network 101. The request indicates that the LEA would like to track any mobile units that are in proximity to a targeted mobile unit. The information targeted can be both signaling data and content. As the target mobile unit changes position within the provider's network, the MSC will track the target mobile unit's location. As the target mobile unit moves, the MSC defines a geographical area around the target mobile unit's current location, the size of which may be configureable. Any other mobile unit in the wireless network within this geographic area will be subject to the collection of information. Depending on the court order received this information may just be a list of the subscriber identities or it may track the signaling messages, the call content of all mobile units surrounding the target mobile unit, or both. These mobile units will not be considered permanent targets, once they leave the defined geographic area around the target, they will no longer be subjected to collection of information about their activity.

In accordance with an exemplary embodiment, the LEA requests a wireless network to track a targeted mobile unit. The request is for the wireless network to perform lawful intercept of the target mobile unit. The request includes the ID of the target mobile unit and the distance of the lawful intercept request.

The wireless network distributes the information included in the request to the mobile switching centers (MSCs) that it controls.

When the target mobile unit powers on, the wireless network defines a geographic area around the targeted mobile unit. This can be accomplished by the MSC. The target area is preferably an area defined by the radius about the target mobile unit.

The target mobile unit sends a registration message to its wireless network, which registration message includes the ID of the target mobile unit and the location of the mobile unit.

The wireless network sends location report to the LEA. The location report preferably includes the geographic coordinates of the target mobile unit, preferably GPS coordinates.

The LEA identifies from the location report that the target mobile unit is a targeted mobile unit and that it wants the identity of other mobile units that are located within the predetermined proximity to the target mobile unit.

To ensure that all mobile units are identified, not just mobile units that are using the wireless network that the targeted mobile unit uses, the LEA sends a track mobile message to any wireless networks that cover the geographical area.

Upon receiving track mobile message, a second wireless network determines which MSCs provide coverage to the geographic area that was included in track mobile message. The second wireless network typically includes a plurality of MSCs. In accordance with an exemplary embodiment, this would be done by all wireless networks that were sent the track mobile message.

The wireless network defines a geographical area based on the location of the target mobile unit.

As other mobile units that are located within the geographical area communicate with their wireless networks, their identities are recorded.

The communication with the wireless network can be any message sent from a mobile unit, such as registration messages, call originations, status updates, or any other message sent to the wireless network. The identity of each mobile unit can be, for example, the MIN/IMSI/MSISDN, the phone number, or any other unique identification of the mobile unit.

The second wireless network sends a message to the LEA that includes all mobile units that were in the geographical area during this reporting period. Each wireless network that was sent a track mobile message would also report the mobile units from their network that were within the geographical area during this reporting period. This message is preferably sent at a predetermined interval or when the interception has concluded.

The first wireless network assembles the list of nearby mobile units received into a list. There may be occasions when a mobile unit is included on lists from multiple MSCs, for example when it is located in a border area between two MSCs. In this scenario, the wireless network can have their Law Enforcement Gateway (LIG) combine the results from each MSC and make one list that includes each unique mobile unit identity that came into the identified geographic area.

The first wireless network sends the combined list of all mobile units that were located within the geographic area for any length of time during the predetermined time period to the LEA.

At predetermined intervals the wireless network compiles a list of all mobile units that were located within the geographical area during the predetermined time interval.

At some point the targeted mobile unit may change location. Upon detecting the change in location of the targeted mobile unit, the wireless network defines a new geographical area for surveillance. The wireless network preferably removes the previous geographical area from its system and use the new geographical location of the targeted mobile unit to record the identities of proximate mobile units.

The wireless network sends an updated location message to the LEA, the message preferably includes the new location of the targeted mobile unit.

The LEA determines which wireless networks have been notified of the location of the targeted mobile unit. Since the targeted mobile unit has moved from its previous location, the wireless networks that were notified of the previous location of the targeted mobile unit need to remove this location from their surveillance list. The LEA sends a location update message to all wireless network that were requested to alert the LEA of the presence of other mobile units in proximity to the targeted mobile unit.

The process of identifying mobile units that are in the geographical area around the target mobile unit, updating the LEA of the mobile units in this geographical area, updating the location of the target mobile unit, and updating the wireless networks preferably repeats until the LEA cancels the surveillance request. Alternately, the process can repeat for a specified period of time.

### BRIEF DESCRIPTION OF THE SEVERAL VIEWS OF THE DRAWINGS

FIG. 1 depict a wireless network in accordance with an exemplary embodiment of the present invention.

FIG. 2 depicts a flow diagram in accordance with an exemplary embodiment of the present invention.

### DETAILED DESCRIPTION OF THE INVENTION

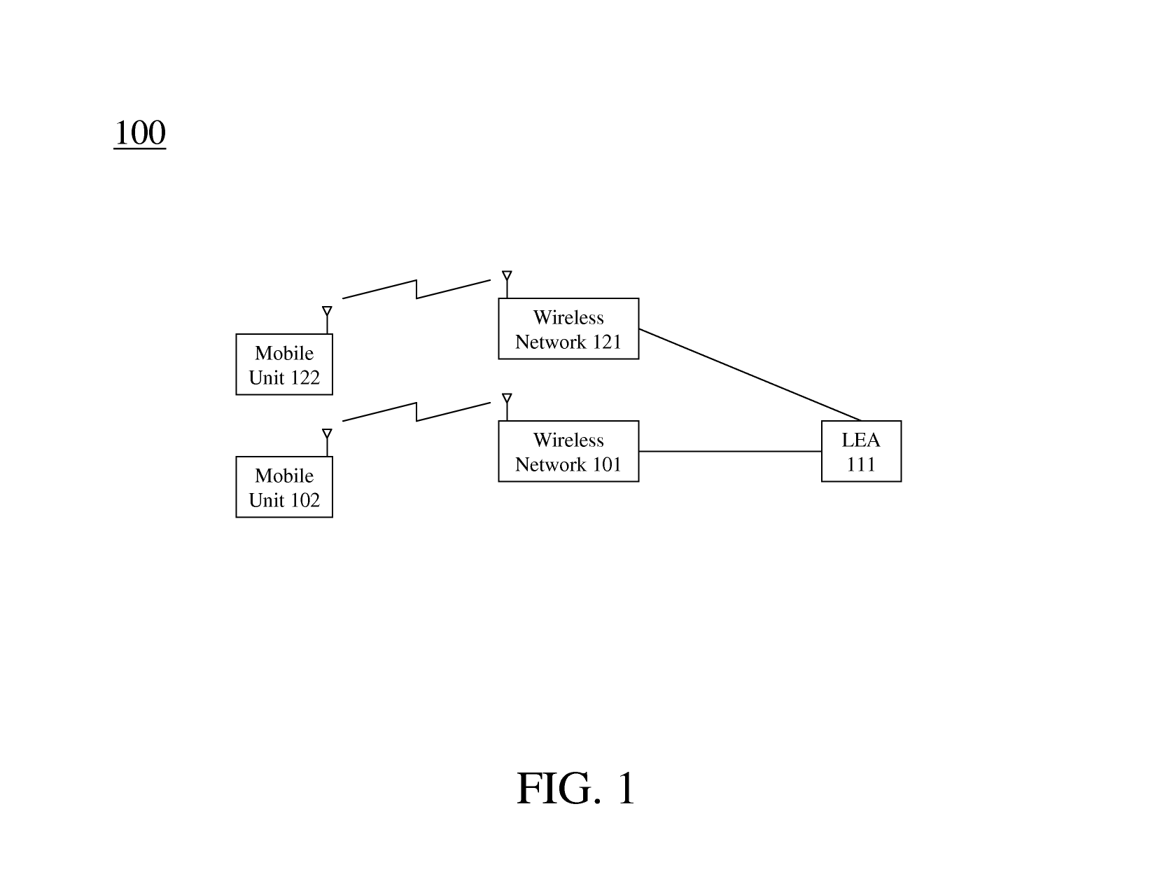

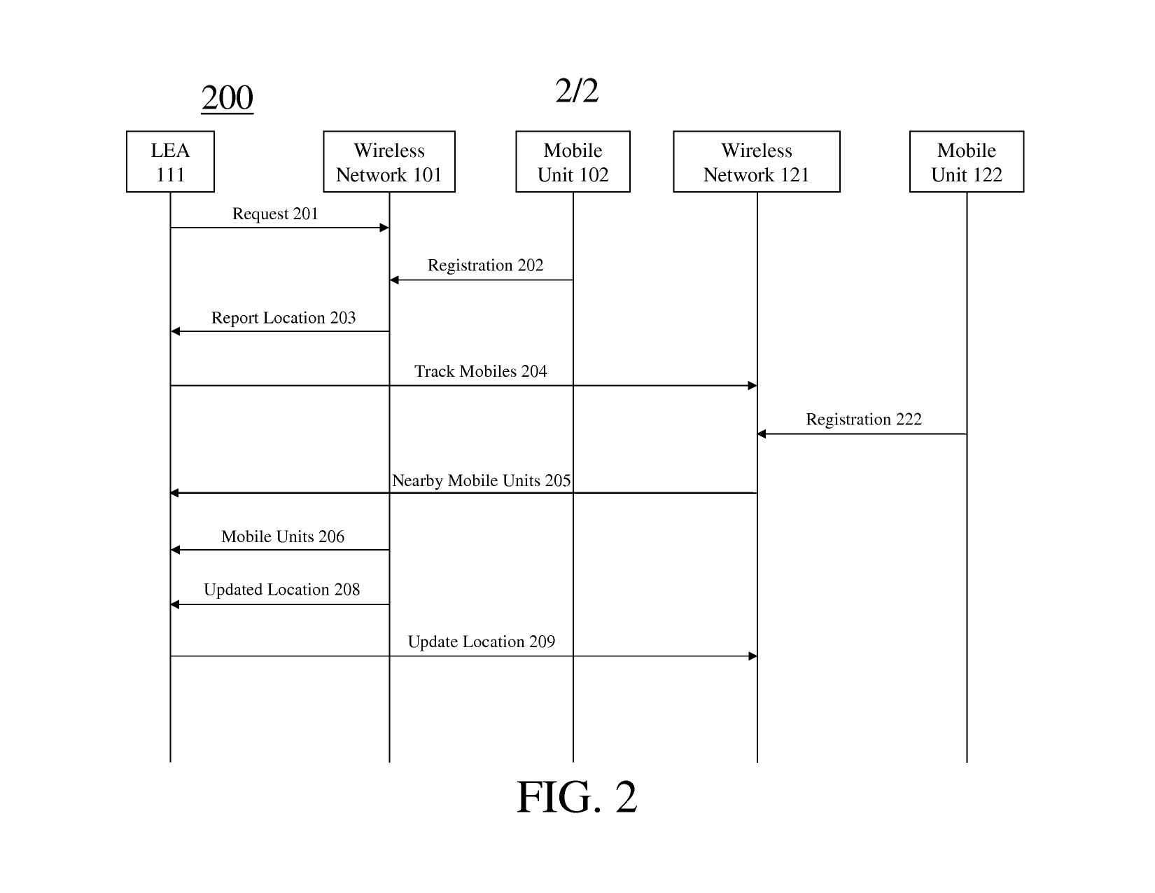

An exemplary embodiment of the present invention can be better understood with reference to FIGS. 1 and 2. FIG. 1 depicts a communication network 100 including wireless network 101, wireless network 121, mobile unit 102, mobile unit 122, and law enforcement agency 111.

In accordance with an exemplary embodiment, wireless network 101 comprises a plurality of base stations and other network elements that allow wireless network 101 to process wireless communications. Wireless network 101 communicates with mobile unit 102 via any of a plurality of air interfaces.

Similarly, wireless network 121 comprises a plurality of base stations and other network elements that allow wireless network 121 to process wireless communications. Wireless network 121 communicates with mobile unit 122 via any of a plurality of air interfaces.

Mobile unit 102 is a mobile device that communicates with wireless network 101, preferably using a wireless air interface.

Mobile unit 122 is a mobile device that communicates with wireless network 121, preferably using a wireless air interface.

Law enforcement agency (LEA) 111 is an agency that is legally authorized to perform surveillance activities. For example, LEA 111 can be the Federal Bureau of Investigation (FBI), state police departments, or local police departments.

FIG. 2 depicts a flow diagram 200 in accordance with an exemplary embodiment of the present invention. In accordance with an exemplary embodiment, LEA 111 submits a court order to wireless network 101 that in addition to tracking signaling and content that a list of subscribers surrounding the target mobile unit be recorded. As the target mobile unit changes position within the provider's network, the MSC will track the target mobile unit's location. As the target mobile unit moves, the MSC defines a geographical area around the target mobile unit's current location, the size of which may be configureable. Any other mobile unit in the wireless network within this geographic area will be subject to the collection of information. Depending on the court order received this information may just be a list of the subscriber identities or it may track the signaling messages, the call content of all mobile units surrounding the target mobile unit, or both. These mobile units will not be considered permanent targets, once they leave the defined geographic area around the target, they will no longer be subjected to collection of information about their activity.

In accordance with an exemplary embodiment, LEA 111 sends Request message 201 to wireless network 101. Request message 201 is a message that requests wireless network 101 to perform lawful intercept of a target mobile unit. In accordance with an exemplary embodiment, request message 201 includes the ID of the target mobile unit and the distance of the lawful intercept request. For example, LEA 111 could request wireless network 101 to report every target that comes within fifty feet of the target mobile unit.

Wireless network 101 distributes the information included in request message 201 to the mobile switching centers (MSCs) that it controls. Wireless network 101 typically includes a plurality of MSCs.

When the target mobile unit, mobile unit 102 in the exemplary embodiment, powers on, wireless network 101 defines a geographic area around mobile unit 102. This can be accomplished by the MSC. The target area is preferably an area defined by the radius about mobile unit 102.

Mobile unit 102 sends Registration message 202 to wireless network 101. Registration message 202 includes the ID of mobile unit 102 and the location of mobile unit 102.

Wireless network 101 sends Report Location message 203 to LEA 111. Report Location message 203 preferably includes the geographic coordinates of mobile unit 102, preferably GPS coordinates.

LEA 111 identifies from Report Location message 203 that mobile unit 102 is a targeted mobile unit and that it wants the identity of other mobile units that are located within the predetermined proximity to mobile unit 102.

To ensure that all mobile units are identified, not just mobile units that are using the wireless network that mobile unit 102 uses, LEA 112 sends Track Mobile message 204 to wireless network 121. It should be understood that LEA 121 sends a track mobile message to every wireless network that provides coverage within the predetermined proximity. For the sake of clarity, only one additional wireless network, wireless network 121, is depicted. Track mobile message 204 preferably includes the geographic area that it is requesting wireless network 121 to monitor.

Upon receiving Track Mobile message 204, wireless network 121 determines which MSCs provide coverage to the geographic area that was included in track mobile message 204. Wireless network 121 typically includes a plurality of MSCs. In accordance with an exemplary embodiment, this would be done by all wireless networks that were sent the track mobile message.

Wireless network 121 defines a geographical area based on the location of the target mobile unit.

As other mobile units that are located within the geographical area communicate with their wireless networks, their identities are recorded. In this exemplary embodiment, mobile unit 122 sends registration message 222 to wireless network 121. The communications with their wireless networks can be registration messages, call originations, status updates, or any other message sent to the wireless network. The identity of each mobile unit can be, for example, the MIN/IMSI/MSISDN, the phone number, or any other unique identification of the mobile unit. It should be understood that wireless network 121 would provide service for a plurality of mobile units, but only one, mobile unit 122, is depicted in FIG. 1 for clarity.

Wireless network 121 sends Nearby Mobile Units message 205 to LEA 111. Nearby Mobile Units message 205 includes the identity of all mobile units that are or have been within the geographical area during this reporting period. Each wireless network that was sent a track mobile message would also report the mobile units from their network that were within the geographical area during this reporting period. In an exemplary embodiment, Nearby Mobile Units message 205 is sent at a predetermined interval. In a further exemplary embodiment, Nearby Mobile Units message 205 is sent when the interception has concluded.

Wireless network 101 assembles the list of nearby mobile units received into a list. There may be occasions when a mobile unit is included on lists from multiple MSCs, for example when it is located in a border area between two MSCs. In this scenario, wireless network 101 can have their Law Enforcement Gateway (LIG) combine the results from each MSC and make one list that includes each unique mobile unit identity that came into the identified geographic area.

Wireless network 101 sends mobile units message 206 to LEA 111. Mobile units message 206 includes the combined list of all mobile units that were located within the geographic area for any length of time during the predetermined time period.

Wireless network 121 records all mobile units that are located within the geographical area. Wireless network 121 detects that a mobile unit is located within the geographical area when it receives a message from a mobile unit. The message can be a registration message, a call origination, or any other message sent to wireless network 121. The identity of each mobile unit can be, for example, the MIN/IMSI/MSISDN, the phone number, or any other unique identification of the mobile unit.

At predetermined intervals wireless network 121 compiles a list of all mobile units that were located within the geographical area during the predetermined time interval.

In accordance with an exemplary embodiment, mobile unit 102 changes location.

Upon detecting the change in location of mobile unit 102, wireless network 101 defines a new geographical area for surveillance. Wireless network 101 preferably removes the previous geographical area from its system and use the new geographical location of mobile unit 102 to record the identities of proximate mobile units.

Wireless network 101 sends Updated Location message 208 to LEA 111. Updated Location message 208 preferably includes the identity of mobile unit 102 and the new location of mobile unit 102.

LEA 111 determines which wireless networks have been notified of the location of mobile unit 102. Since mobile unit 102 has moved from its previous location, the wireless networks that were notified of the previous location of mobile unit 102 need to remove this location from their surveillance list. LEA 111 sends Update Location message 209 to wireless network 121. Update Location message 209 preferably includes the identifier of mobile unit 102. In an exemplary embodiment, LEA 111 sends a similar message to all wireless networks that were tracking the geographical area of mobile unit 102.

The process of identifying mobile units that are in the geographical area around target mobile unit 102, updating LEA 111 of the mobile units in this geographical area, updating the location of mobile unit 102, and updating wireless network 121 preferably repeats until LEA 111 cancels the surveillance request. Alternately, the process can repeat for a specified period of time.

While this invention has been described in terms of certain examples thereof, it is not intended that it be limited to the above description, but rather only to the extent set forth in the claims that follow.

We claim:

1. A method for performing lawful intercept of mobile units in proximity to a target mobile unit comprising:
identifying a first mobile unit to target, the step of identifying including specifying a geographical area; and
recording information about a second mobile unit that comes enters the geographical area.

2. A method for performing lawful intercept of mobile units in proximity to a target mobile unit in accordance with claim 1, wherein the geographical area comprises a radius about the first mobile unit.

3. A method for performing lawful intercept of mobile units in proximity to a target mobile unit in accordance with claim 1, wherein the information comprises the identity of the second mobile unit.

4. A method for performing lawful intercept of mobile units in proximity to a target mobile unit in accordance with claim 1, wherein the information comprises signaling messages of the second mobile unit.

5. A method for performing lawful intercept of mobile units in proximity to a target mobile unit in accordance with claim 1, wherein the information comprises call content of a call that the second mobile unit participates in.

6. A method for performing lawful intercept of mobile units in proximity to a target mobile unit in accordance with claim 1, the method further comprising the step of stopping the recording of information when the second mobile unit leaves the geographical area.

7. A method for performing lawful intercept of mobile units in proximity to a target mobile unit in accordance with claim 1, wherein the step of specifying a geographical area comprises specifying a geographical area when the first mobile unit powers on.

8. A method for performing lawful intercept of mobile units in proximity to a target mobile unit in accordance with claim 1, the method further comprising the step of sending the recorded information about the second mobile unit to a law enforcement agency.

9. A method for performing lawful intercept of mobile units in proximity to a target mobile unit in accordance with claim 8, wherein the step of sending the recorded information about the second mobile unit to a law enforcement agency comprises sending the GPS coordinates of the second mobile unit.

10. A method for performing lawful intercept of mobile units in proximity to a target mobile unit in accordance with claim 8, wherein the step of sending the recorded information about the second mobile unit to a law enforcement agency is done at a predetermined interval.

11. A method for performing lawful intercept of mobile units in proximity to a target mobile unit in accordance with claim 8, wherein the step of sending the recorded information about the second mobile unit to a law enforcement agency is done when the interception of information has concluded.

12. A method for performing lawful intercept of mobile units in proximity to a target mobile unit in accordance with claim 1, wherein the step of recording information about a second mobile unit that comes enters the geographical area comprises receiving a registration message from the second mobile unit.

13. A method for performing lawful intercept of mobile units in proximity to a target mobile unit in accordance with claim 1, wherein the step of recording information about a second mobile unit that comes enters the geographical area comprises receiving a call origination message.

14. A method for performing lawful intercept of mobile units in proximity to a target mobile unit in accordance with claim 1, wherein the step of recording information about a second mobile unit that comes enters the geographical area comprises receiving a status update from the second mobile unit.

15. A method for performing lawful intercept of mobile units in proximity to a target mobile unit in accordance with claim 1, wherein the step of recording information about a second mobile unit that comes enters the geographical area comprises recording the MIN of the second mobile unit.

16. A method for performing lawful intercept of mobile units in proximity to a target mobile unit in accordance with claim 1, wherein the step of recording information about a second mobile unit that comes enters the geographical area comprises recording the IMSI of the second mobile unit.

17. A method for performing lawful intercept of mobile units in proximity to a target mobile unit in accordance with claim 1, wherein the step of recording information about a second mobile unit that comes enters the geographical area comprises recording the MSISDN of the second mobile unit.

18. A method for performing lawful intercept of mobile units in proximity to a target mobile unit in accordance with claim 1, the method further comprising the step of modifying the geographical area when the first mobile unit changes location.

19. A method for performing lawful intercept of mobile units in proximity to a target mobile unit in accordance with claim 18, the method further comprising the step of removing the initial geographical area.

20. A method for performing lawful intercept of mobile units in proximity to a target mobile unit in accordance with claim 1, wherein the step of recording information about a second mobile unit that comes enters the geographical area is performed at multiple wireless networks.
